(19) United States
(12) Patent Application Publication
(10) Pub. No.: US 2004/0131736 A1
(43) Pub. Date: Jul. 8, 2004

(54) Devices and methods for prolonging the storage life of produce

(75) Inventors: Yong Pan, Covington, KY (US); David Kent Rollins, Cincinnati, OH (US); Michael David Cummings, West Chester, OH (US); J. Michael Bills, West Chester, OH (US)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company, Cincinnati, OH (US)

(21) Appl. No.: 10/651,322

(22) Filed: Aug. 28, 2003

Related U.S. Application Data
(63) Continuation of application No. PCT/US02/06201, filed on Mar. 1, 2002.
(60) Provisional application No. 60/273,264, filed on Mar. 2, 2001.
(60) Provisional application No. 60/333,441, filed on Nov. 26, 2001.

(51) Int. Cl. B65B 29/00; B65B 61/20; B65B 59/00; B65B 3/04; A23K 3/02

(52) U.S. Cl. 426/419; 53/400; 53/474

(57) ABSTRACT

A package for prolonging the storage life of produce is disclosed. The package comprises a gas permeable container and an atmosphere modifying device contained within the container. The atmosphere modifying device comprises a carbon dioxide emitter, an oxygen scavenger, and an optional ethylene scavenger. Produce is stored in the container with the device. The device and container are suitable to use in a consumer's home (e.g., kitchen cabinet or refrigerator).

### CROSS REFERENCE TO RELATED APPLICATIONS

This application is a continuation application of prior copending International Application No. PCT/US02/06201, filed Mar. 1, 2002, designating the U.S., which claims the benefit of U.S. Provisional Application No. 60/273,264, filed Mar. 2, 2001 and 60/333,441, filed Nov. 26, 2001.

### FIELD OF THE INVENTION

This invention relates to devices and methods for prolonging the storage life of produce. More particularly, this invention relates to packages, devices, and methods for prolonging the storage life of produce in consumers' homes.

### BACKGROUND

Virtually all consumers throw away produce because of spoilage. They are interested in easy ways to keep their produce fresher longer, thus avoiding waste, improving their diets, and minimizing trips to the store. Therefore, it is an object of this invention to provide a package that consumers can use in their homes to prolong the storage life of produce.

Common causes for fresh produce spoilage include produce respiration and ripening, water loss, chill injury, mechanical damage, and invasion by microorganisms. Reducing respiration of produce delays ripening, thereby prolonging storage life. Respiration can be reduced by lowering oxygen content and ethylene content and increasing carbon dioxide content of the atmosphere in which the produce is stored. Reducing respiration inhibits enzymatic reactions and reduces substance oxidation, thereby preserving or improving texture, flavor, and nutritional value. Reducing respiration also retards fungal growth, thereby increasing safety.

Various methods for preventing spoilage of produce by wholesalers and retailers have been used. For example, produce can be placed in a package after harvest. The headspace of the package is then flushed with a gas mixture having a specific content of each gas (e.g., oxygen, carbon dioxide, and nitrogen). However, this method suffers from the drawback that as soon as the package is opened, the gas mixture in the headspace is changed. The package is not reusable.

An alternative method used by wholesales and retailers is to add one or more atmosphere modifying substances to a shrink wrapped or film covered package containing produce. However, this method also suffers from the drawback that the package is not reusable because once the wrap or film is ripped off by the consumer, it cannot be reused. Furthermore, many of the atmosphere modifying substances disclosed are not food safe, so if the atmosphere modifying substances contact the produce, it will be spoiled.

Another method for preventing spoilage of produce is to store the produce in a container with a valve system for letting in ambient air and venting container air when the oxygen, carbon dioxide, and ethylene concentration become too high. However, this method suffers from the drawback that the content of each gas in the container cannot be modified from that of ambient air.

One method for lowering the oxygen content in the headspace of a container is to incorporate an oxygen scavenging polymer in the plastic or polymer materials of construction of the container containing the food or beverage, or coat the inside surface of the container with an oxygen scavenging coating. However, this method suffers from the drawback that the contents of ethylene and carbon dioxide in the container are not controlled.

Therefore, it is an object of this invention to provide methods and devices for controlling oxygen, carbon dioxide, and optionally ethylene content of a package containing fresh produce. It is a further object of this invention to provide reusable devices and packages for prolonging the storage life of produce in consumers' homes.

### SUMMARY OF THIS INVENTION

This invention relates to packages, devices, and methods for prolonging the storage life of produce. The package comprises a container and an atmosphere modifying device contained within the container. The atmosphere modifying device comprises a carbon dioxide emitter, an oxygen scavenger, and optionally an ethylene scavenger. Produce is stored in the container with the device. The device and container are suitable to use in a consumer's home (e.g., kitchen cabinet, countertop, or refrigerator). The packages and devices according to this invention can extend the storage life of produce from about 1 to about 2 weeks up to about 3 to about 4 weeks or more depending on the type of produce.

The carbon dioxide emitter modifies the atmosphere in the headspace of the container to comprise about 0.5 to about 40 vol % carbon dioxide. The oxygen scavenger modifies the atmosphere in the headspace of the container to comprise about 2 to about 21 vol % oxygen. The ethylene scavenger modifies the atmosphere in the headspace of the container to comprise 0 to about 10 parts per million ethylene Surprisingly, it has been found that the storage life of the produce is extended even when the modified atmosphere is periodically interrupted, as when the container is reopened, produce is added or removed therefrom, and the container is reclosed. Therefore, the packages and devices of this invention are reusable.

The package or device may further comprise one or more of the following optional components:

an activator (such as a water capsule),

a controller controlling the release rate of carbon dioxide and the scavenging rate of oxygen and/or ethylene,

a moisture controlling mechanism (such as an absorbent material),

a biological active (such as yeast with carbohydrate),

a CO emitter, and

an antimicrobial emitter.

### BRIEF DESCRIPTION OF THE DRAWINGS

FIG. 1 is an atmosphere modifying device according to this invention.

FIG. 2 is a top view of an atmosphere modifying device according to this invention.

FIG. 3 is a package according to this invention containing produce.

### DETAILED DESCRIPTION OF THE INVENTION

All percentages are by volume unless otherwise indicated. All U.S. Patents cited herein are hereby incorporated by reference.

### Definitions

The following is a list of definitions, as used herein.

“Carbon dioxide emitter” means a material capable of adding carbon dioxide to the headspace of a container. Addition can be by chemical reaction or physical means.

“Desiccant” means a material that absorbs or adsorbs water to an extent that lowers the humidity in the headspace of a container.

“Ethylene scavenger” means a material capable of removing ethylene from the headspace of a container. Removal can be by chemical reaction or by physical absorption or adsorption.

“Gas impermeable” means that the material has a gas transmission rate less than 1000 milliliters of gas, such as oxygen and carbon dioxide, per square meter of surface area per 24 hour period at one atmosphere and 25° C. based on United States standard method ASTM D 1434.

“Gas permeable” means that the material has a gas transmission rate of at least 1000 milliliters of gas, such as oxygen and carbon dioxide, per square meter of surface area per 24 hour period at one atomsphere and 25° C. based on United States standard method ASTM D 1434. A gas permeable material can be, for example, a plastic film or sheeting, paper, fabric, or metallic foil.

“GRAS” means generally recognized as safe. GRAS materials may contact food without appreciable risk to the produce or the consumer thereof.

“Oxygen scavenger” means a material capable of removing oxygen from the headspace of a container. Removal can be chemical or by physical absorption or adsorption. Chemical removal can occur by oxidation of the material (e.g., by forming a chemical bond between at least one oxygen atom of the oxygen molecule and a molecule of the material). Physical removal can be where oxygen molecules are entrapped within the material.

“Reusable” means that the container in this invention can be reopened and reclosed at least one time after produce and a device according to this invention are placed in the container and the container is closed initially, without replacing the atmosphere modifying device therein. Produce may be added or removed from the container and the modified atmosphere will be reestablished when the container is reclosed.

### Package

This invention relates to a package for prolonging the storage life of produce. The package comprises:

i. a container, and

ii. an atmosphere modifying device contained within the container.

The atmosphere modifying device comprises:

a. a carbon dioxide emitter,

b. an oxygen scavenger, and

c. an optional ethylene scavenger.

### Container

The container is gas permeable. The container has sufficient oxygen permeability such that a sufficient amount of oxygen from the ambient air can enter the container to maintain at least about 2 vol % oxygen in the headspace of the container when produce and the device are placed therein, and the container is closed. However, the container has sufficient integrity to maintain the modified atmosphere in its headspace when produce and an atmosphere modifying device are placed therein.

The container can be made gas permeable by virtue of its materials of construction. For example, although the exact permeability depends on the choice of materials of construction, the thickness, and the integrity of the closure, suitable materials of construction include: polyethylene, polyvinyl chloride, polyvinylidene chloride, ethylene-vinyl acetate copolymers, acetate cellulose, polystyrol, polypropylene, polyester, polyvinyl alcohol, polycarbonate, combinations thereof, and others.

Alternatively, the container can be made gas permeable by having one or more holes (e.g., pinholes, perforations, or vents) therein, for example, when the materials of construction of the container are not gas permeable (e.g., glass or Saran Wrap™ available from S. C. Johnson Home Storage, Inc. of Racine, Wis.).

The size of the container is preferably such that headspace is minimized, i.e., the container is selected such that the produce just fits inside. Suitable containers are typically about one cup to about ten gallons in size. The container is preferably reusable, i.e., capable of being (re)opened and (re)closed more than once.

The container comprises produce housing means and closing means. In one embodiment of the invention, the produce housing means can be rigid, e.g., comprising ajar, box, or other receptacle. In this embodiment, the closing means may comprise a top or lid. Examples of containers according this embodiment are known in the art and are commercially available, e.g., RUBBERMAID® containers available from Rubbermaid Incorporated of Wooster, Ohio or TUPPERWARE® containers available from Dart Industries, Inc., dba Tupperware Home Parties Corp. of Deerfield, Ill. In an alternative embodiment of the invention, the produce housing means can be flexible, e.g., comprising a bag or sack and the closing means can comprise, for example, a seal or zipper. Examples of containers according to this embodiment are known in the art and are commercially available, e.g., ZIPLOC® bags available from S. C. Johnson Home Storage, Inc. of Racine, Wis.

The container may further comprise holding means for an atmosphere modifying device, described below. The holding means can be, for example, a separate compartment in the produce housing means (e.g., receptacle) or closing means (e.g., lid).

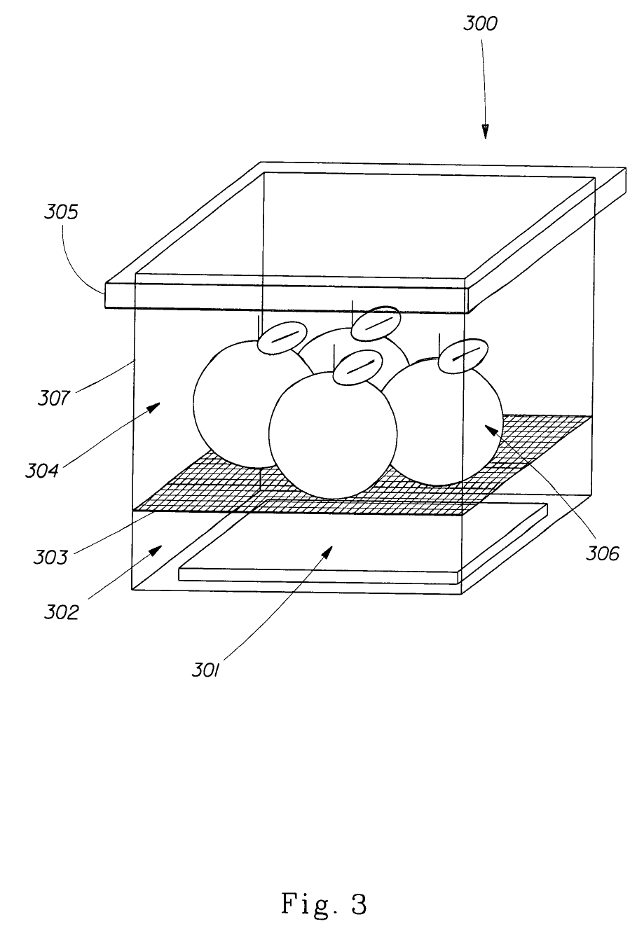

An atmosphere modifying device is placed in the container with the produce. The device may be placed anywhere in the container, i.e., it may or may not contact the produce in the container. Preferably, the device does not contact the produce. In one embodiment of the invention, the container has two (or more) compartments separated by a liquid and vapor permeable barrier such as a screen or mesh. The produce is placed in one compartment and the device is placed in another compartment. This embodiment is exemplified in FIG. 3. The package 300 comprises a container 307 having a lower compartment 302 and an upper compartment 304 covered by a lid 305. The lower compartment 302 and upper compartment 304 are separated by a liquid permeable mesh 303. An atmosphere modifying device 301 according to this invention is placed in the lower compartment 302. Produce 306 is placed in the upper compartment 304 and the container 307 is closed with the lid 305. Any liquid, e.g., water, present on the produce 306 may drain through the barrier 303 and collect in the lower compartment 302. This prevents the produce 306 from sitting in a pool of liquid. In this embodiment, if the atmosphere modifying device 301, or the portion thereof containing the carbon dioxide generator, is liquid permeable, any liquid (e.g., water or an aqueous composition) draining from the produce may contact the device and act as an accelerator.

In an alternate embodiment, the container 307 and the atmosphere modifying device 301 are integrated into a single component (not shown).

### Atmosphere Modifying Device

The atmosphere modifying device comprises atmosphere modifiers comprising a carbon dioxide emitter, an oxygen scavenger, and preferably an ethylene scavenger. Typically, the atmosphere modifiers are contained within a gas permeable material such as paper or fabric. The gas permeable material may be liquid permeable or liquid impermeable. In an alternative embodiment of the invention, more than one gas permeable material may be used, for example, a liquid permeable material may be used to house the carbon dioxide emitter and a liquid impermeable material may be used to house the oxygen scavenger and any optional ethylene scavenger.

### Atmosphere Modifiers

In a preferred embodiment, the atmosphere modifiers used in the methods and devices of this invention appear on an approved list for use with food. In the United States, for example, ingredients pre-approved for food use are listed in the United States Code of Federal Regulations (C.F.R.), Title 21. Ingredients that are pre-approved for food use are the Direct Food Additives and GRAS materials. Other ingredients that are well established as safe, or have adequate toxicological and safety pedigree, can be added to existing lists or approved by a self-GRAS affirmation process.

The atmosphere modifiers used in the methods and devices of this invention comprise a carbon dioxide emitter, an oxygen scavenger, and preferably an ethylene scavenger. The carbon dioxide emitter adds carbon dioxide to the headspace of the container at a rate greater than about 1 cubic centimeter per hour. Typically, the rate of carbon dioxide generation is about 2 to about 5000 cubic centimeters per hour, preferably the rate is greater than about 5 to about 5000 cubic centimeters per hour. The rate of carbon dioxide emission is controlled by varying several properties including the selection, amounts, and average particle size of the ingredients in the carbon dioxide emitter. The carbon dioxide emitter comprises an organic acid and a carbonate compound. The molar ratio of organic acid to carbonate compound is typically about 0.3:1 to about 5:1, preferably about 0.5:1 to about 1:1.

The organic acid is exemplified by acetic acid, aconitic acid, adipic acid, alanine, ascorbic acid, benzoic acid, citric acid, dehydroacetic acid, fumaric acid, gluconic acid, glutaric acid, hydroxyacetic acid, lactic acid, lysine, maleic acid, malic acid, propionic acid, salicyclic acid, sorbic acid, succinic acid, tartaric acid, and combinations thereof.

The carbonate compound can be a carbonate, a bicarbonate, or a combination thereof. The carbonate is typically sodium carbonate, and the bicarbonate is typically sodium bicarbonate. Other suitable carbonate compounds that can be used in addition to or instead of sodium carbonate and sodium bicarbonate include potassium carbonate, magnesium carbonate, calcium carbonate, and ferrous carbonate. The molar ratio of carbonate to bicarbonate is about 0:1 to about 100:1, preferably about 0:1 to about 10:1. The average particle size of the carbonate compound is typically about 5 micrometers to about 1000 micrometers, preferably about 5 to about 150 micrometers. The organic acid and the carbonate compound are typically mixed together.

The oxygen scavenger removes oxygen from the headspace of the container at a rate greater than about 5 cubic centimeters per gram per hour. The rate at which oxygen is scavenged is controlled by varying the selection and amounts of ingredients in the oxygen scavenger. In one embodiment of the invention, the oxygen scavenger comprises an iron source mixed with a salt. The iron source can be, for example, food grade iron powder, ferrous carbonate, or combinations thereof. The salt can be, for example, sodium chloride or another electrolyte, or combinations thereof. The ratio of the amounts of iron source to salt is typically about 0.1:1 to about 10:1. The moisture in the container activates the reaction to scavenge oxygen.

In an alternative embodiment of the invention, the oxygen scavenger can be ferrous carbonate and ascorbic acid.

The ethylene scavenger selected from the group consisting of CaO₂, modified alumina, zeolite, zeolite impregnated with permanganate, activated carbon, and combinations thereof. The ratio of the amount of ethylene scavenger to produce is typically about 1:10 to about 1:5000.

Optionally, an ethylene blocker, such as cyclopropane can be added in addition to or instead of the ethylene scavenger. The ethylene blocker reduces or eleminates the negative effects of ethylene on produce.

The types and amounts of the atmosphere modifiers present in the device depend on various factors including the size of the container and the type of produce to be stored. In a preferred embodiment of the invention, the device comprises a mixture of about 5 to about 15 grams of carbonate compound mixed with about 5 to about 20 grams of organic acid packed in a gas permeable and liquid impermeable material such as Tyvek paper. The size of the device is typically about 4 inches by about 4 inches. A device of this size is suitable to use in a 1 quart to 2 gallon plastic bag or rigid (e.g., TUPPERWARE®) container. The atmosphere modifying device is typically stored in a dry, sealed container to prevent the atmosphere modifiers from being spent before the device reaches the consumer.

A device according to this invention modifies the atmosphere in the headspace of the container such that the modified atmosphere comprises about 0.5 to about 40 vol % carbon dioxide, about 2 to about 21 vol % oxygen, and 0 to about 10 parts per million ethylene. Preferably, the amount of carbon dioxide is about 1 to about 20 vol %. Preferably, the amount of oxygen is about 2 to about 15 vol %. Preferably the amount of ethylene is 0 to about 1 part per million. More preferably, the amount of carbon dioxide is about 3 to about 15 vol %, the amount of oxygen is about 5 to about 10 vol %, and the amount of ethylene is about 0 to about 0.1 part per million.

The device achieves the modified atmosphere in the headspace of the container within about 24 hours after the device and produce are placed in the container and the container is closed (or reclosed). Typically the device achieves the modified atmosphere in about 0.5 to about 24 hours, preferably about 4 to about 8 hours.

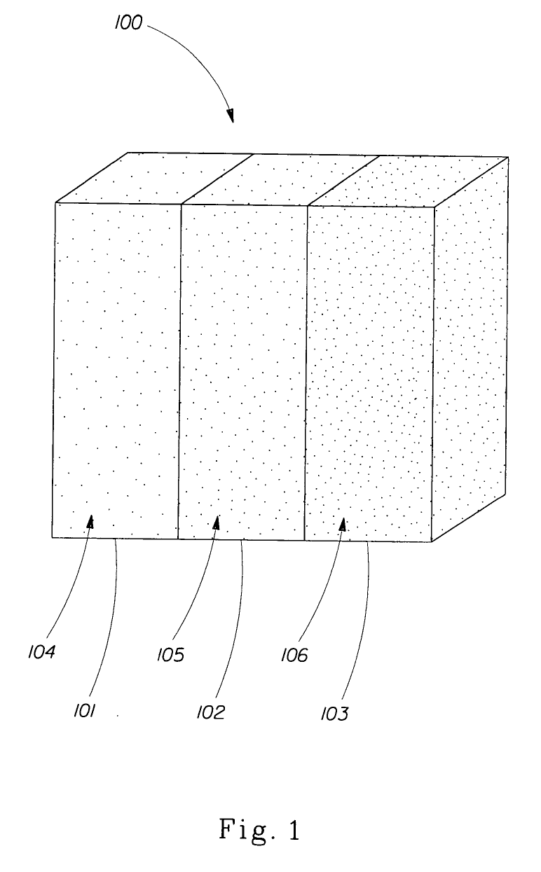

FIG. 1 shows a device 100 according to one embodiment of this invention. The device 100 comprises three compartments 101, 102, 103. The first compartment 101 contains the carbon dioxide emitter 104. The second compartment 102 contains the oxygen scavenger 105. The third compartment 103 contains the ethylene scavenger 106.

In an alternative embodiment of this invention, the device may comprise more than one module. For example, a first module may comprise a compartment containing a carbon dioxide emitter. A second module may comprise a compartment containing an oxygen scavenger. An optional third module may comprise a compartment containing an ethylene scavenger. One or more first modules, one or more second modules, and optionally one or more third modules may be placed in a gas permeable container described above, depending on various factors such as the type and amount of produce to be stored in the container. In an alternative embodiment of this invention, a first module may contain both the carbon dioxide emitter and the oxygen scavenger, and an optional second module contains the ethylene scavenger.

The device may further comprise one or more optional components. The optional components are exemplified by:

an activator for increasing the rate of carbon dioxide emission, increasing the rate of oxygen scavenging, or both,

a controller controlling the emission rate of carbon dioxide and the scavenging rate of oxygen or ethylene, or both,

a moisture controlling mechanism (such as an absorbent material),

a biological active (such as yeast with carbohydrate),

a carbon monoxide emitter,

an antimicrobial emitter, and

combinations thereof.

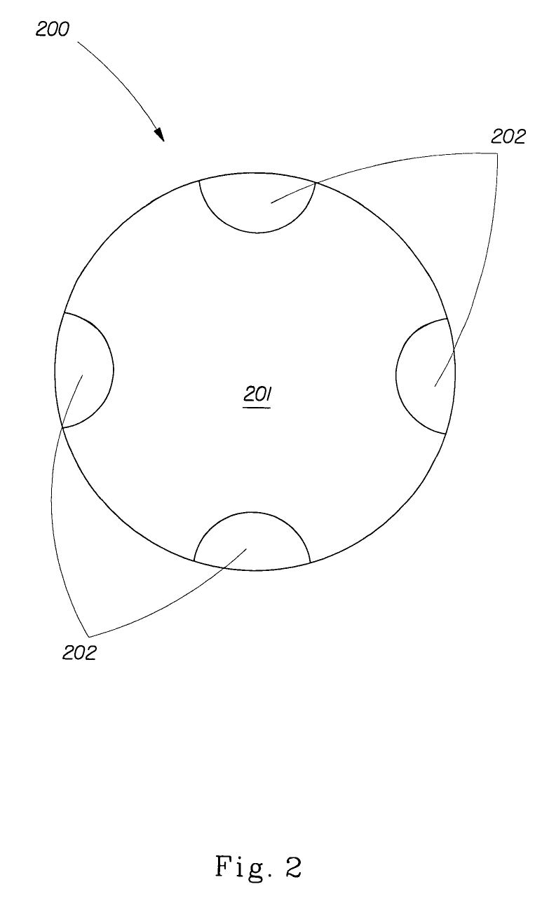

The activator can be one or more water capsules. Water capsules are placed in the device such that when ruptured, the water will contact the carbon dioxide emitter, the oxygen scavenger, or both. FIG. 2 shows a device 200 according to this invention with water capsules 202. The water capsules 202 are in close proximity to the atmosphere modifiers 201. A consumer using the device 200 can manually rupture one or more of the water capsules 202 when putting the device 200 in a container with produce. The number of water capsules 202 to rupture depends on various factors including the amount and type of produce. Preferably, the device 200 will be sold with instructions as to how many water capsules 202 to rupture depending on the type and amount of produce stored in a container with the device 200.

The a controller controlling the emission rate of carbon dioxide and the scavenging rate of oxygen or ethylene, or both, can be a device such as a small container that has adjustable openings for gas flow. The atmosphere modifying devices can be placed inside the controller. The openings can be dialed to fit the needs of specific produce. The controller also prevents contact between the devices and produce.

The moisture controlling mechanism can be an absorbent material such as paper, cloth, or other cellulose derived material. The moisture controlling mechanism prevents the produce from resting in a pool of liquid. Preferably, the moisture controlling mechanism does not change the humidity in the headspace of the package significantly. In a preferred embodiment of the invention, humidity in the head space is typically about 91% to about 100%. This level of humidity can be achieved by the natural respiration of produce in the container. (Desiccants that lower humidity, such as the highly water-absorbing polymers disclosed by Japanese Patent Application 58-193678 (1983), are not suitable for use in this invention.) The biological active can comprise microorganisms such as yeasts. With carbohydrate or other nutrients, the microorganisms will consume oxygen and generate carbon dioxide, thereby modifying the atmosphere. The microorganisms can be genetically engineerd to automatically stop the process when the desired gas composition is reached. The microorganisms may also consume ethylene in addition to or instead of oxygen.

An increased concentration of carbon monoxide may also help reduce respiration of produce and the growth of bacteria. Carbon monoxide can be generated from a chemical or a device.

Antimicrobial gases such as sulfur dioxide can kill bacteria and extend the storage life of produce. Antimicrobial emitters such as sodium bisulfite or devices can be incorporated in the atmosphere modifying devices of this invention.

This invention further relates to a kit comprising:

a) an atmosphere modifying device described above,

b) a gas impermeable packing material containing the atmosphere modifying device,

c) information or instructions, or both, describing how to use the atmosphere modifying device, and

d) optionally, a container described above.

The atmosphere modifying devices of this invention can be stored and shipped in a gas impermeable packing material to prevent the oxygen scavenger, carbon dioxide generator, and any optional ingredients from becoming exhausted before the device reaches the consumer. Examples of suitable gas impermeable packing materials include polyvinylidene chloride copolymers (e.g., Saran Wrap™), nylon, polyethylene terephthalate, ethylene vinyl alcohol copolymers, siloxanes, and others.

The information, instructions, or both describe that use of the kit will prolong the storage life of produce. The information and instructions may be in the form of words, pictures, or both, and the like. In addition or in the alternative, information, instructions, or both, describe methods of using the device (and container, if any) depending on the type and amount of produce to be stored.

### Methods of Use

This invention further relates to a method for prolonging the storage life of produce. The method comprises:

1) placing the produce in a gas permeable container described above with an atmosphere modifying device described above, and

2) closing the container.

The method may further comprise:

3) opening the container to add or remove produce at least one time (e.g., as needed), and

4) closing the container.

The device modifies the atmosphere in the headspace of the container to contain about 0.5 to about 40 volume % carbon dioxide and about 2 to about 21 volume % oxygen when the container is closed (e.g., after step 2) or after step 4)). In a preferred embodiment of the invention, the device further modifies the atmosphere in the headspace of the container to contain about 0 to about 10 parts per million ethylene. More preferably, the device modifies the atmosphere in the headspace of the container to contain about 1 to about 20 vol % carbon dioxide, about 2 to about 15 vol % oxygen, and about 0 to about 1 part per million ethylene. Most preferably, the device modifies the atmosphere in the headspace of the container to contain about 5 to about 10 volume % oxygen, about 3 to about 15 volume % carbon dioxide, and about 0 to about 0.1 part per million ethylene.

The device achieves the modified atmosphere in the headspace of the container within about 0.5 to about 24 hours after the container is closed (e.g., after step 2) or step 4)).

In one embodiment of the invention, the method further comprises washing the produce prior to step 1). The produce can be washed by any conventional means such as by rinsing with water or by using a commercially available product such as FIT® available from the Procter & Gamble Company of Cincinnati, Ohio. In an alternative embodiment of the invention, the produce can be washed by a method comprising direct application to the produce of a dilute aqueous treatment composition having an acidic pH of about 2 to about 5, wherein the dilute aqueous treatment composition comprises:

a) an effective amount to kill or reduce microorganisms on the produce, of an acid, preferably an organic acid selected from the group consisting of acetic acid, aconitic acid, adipic acid, alanine, ascorbic acid, benzoic acid, citric acid, dehydroacetic acid, fumaric acid, gluconic acid, glutaric acid, hydroxyacetic acid, lactic acid, lysine, maleic acid, malic acid, propionic acid, salicyclic acid, sorbic acid, succinic acid, tartaric acid, and mixtures thereof, the level of organic acid preferably being at least about 0.0025% of the dilute aqueous treatment composition;

b) at least about 0.003%, preferably less than about 5% of a surfactant, preferably selected from the group consisting of an anionic surfactant, nonionic surfactant, acid sensitive amphoteric surfactant, and mixtures thereof;

c) an effective amount, to help stabilize the solution interfacial tension or prevent precipitation of the surfactant, of a stabilizing agent, preferably selected from the group consisting of organic nonionic and polymeric adjuncts, salts, and mixtures thereof, said stabilizing agent preferably at a level from about 0.0002% to about 3.5% of the dilute aqueous treatment composition;

d) optionally, an effective amount of a buffer, preferably a toxicologically acceptable organic acid salt buffer, preferably selected from the group consisting of sodium carbonate, sodium bicarbonate, magnesium carbonate hydroxide, and mixtures thereof, said buffer preferably at a level from about 0.0005% to about 3%;

e) optionally, a toxicologically acceptable antifoaming agent;

f) optionally, a toxicologically acceptable preservative;

g) optionally, a perfume;

h) optionally, a flavoring agent;

i) optionally, a coloring agent; and

j) the balance comprising an aqueous carrier comprising water and optionally, low levels of low molecular weight, toxicologically acceptable organic solvents, minor ingredients, or both.

The produce may optionally be drained, dried, or both, after washing.

The packages, devices, and methods of this invention operate at ambient temperature and under refrigeration. Whether to refrigerate the container after produce is placed therein depends on the type of produce to be stored and the preference of the consumer. The packages, devices, and methods of this invention are typically used at temperatures of about 0 to about 30° C.

This invention further relates to a method for promoting the sale of produce, which generally comprises providing informational indicia, such as an advertisement, logo, brochure, sticker, sign, or other printed matter, in association with the produce to indicate and/or communicate to a consumer of the produce that the produce can be kept fresh for longer periods of time by storing the produce in a package according to this invention or storing the produce in a container with a device according to this invention.

### EXAMPLES

These examples are intended to illustrate the invention to one skilled in the art and should not be interpreted as limiting the scope of the invention set forth in the claims.

### Example 1

### Carbon Dioxide Generation

The ingredients listed in Table 1 are placed in a 6 liters desiccator. The bottom of the desiccator is filled with water to achieve a high humidity within the desiccator. CO₂ concentration is measured after 24 hours using Drager gas tubes (Drager Sicherheiheitstechnik GmbH, Germany). The results, also in Table 1, show that a large range of CO₂ concentration and generation rate can be generated by controlling the ratio of carbonate to bicarbonate, the ratio of the acid to carbonates, the addition of moisture absorbents.

TABLE 1

| | Ascorbic | | Silica Gel | % Carbon |
|---|---|---|---|---|
| Experiment # | Acid (g) | NaHCO₃/Na₂CO₃ | (g) | Dioxide |
| 1-1 | 20 | 10/0 | 0 | >20 |
| 1-2 | 20 | 10/0 | 10 | 8 |
| 1-3 | 20 | 10/0 | 5 | >20 |
| 1-4 | 40 | 10/0 | 10 | 12 |
| 1-5 | 20 | 10/0 | 5** | 15 |
| 1-6 | 20 | 1/9 | 0 | 3 |
| 1-7 | 20 | 10/0 | 10 | 8 |
| 1-8 | 20* | 10/0 | 10 | 17 |

*Citric acid is used instead of ascorbic acid in experiment 8.
**Starch is used instead of silica gel in experiment 6.

### Example 2

### Oxygen Scavenging

The ingredients listed in Table 2 are placed in a 6 liters desiccator. The bottom of the desiccator is filled with water to achieve a high humidity within the desiccator. Oxygen concentration is measured after 24 hours using Drager gas tubes (Drager Sicherheiheitstechnik GmbH, Germany). The data shows that mixing the iron with a salt scavenges oxygen. The data also shows that moisture content also affects the rate of oxygen removal.

TABLE 2

| Experiment # | Fe powder (g) | NaCl (g) | Silica Gel (g) | % Oxygen |
|---|---|---|---|---|
| 2-1 | 20 | 0 | 0 | 19 |
| 2-2 | 20 | 0 | 20 | 19 |
| 2-3 | 15 | Saturated | Yes | 5 |
| | | solution | | |
| 2-4 | 15 | 15 | 0 | 12.5 |
| 2-5 | 15 | 15 | 10 | 11.5 |

### Example 3 and Comparative Example 1

### Carbon Dioxide and Oxygen Concentration in Bags/Containers with Produce

Strawberries are purchased from a local grocery store and stored in a refrigerator using the following methods. Carbon dioxide and oxygen concentrations are measured using Drager gas tubes. The bags/containers are opened every 3 to 4 days.

Comparative 1-1 Stored in an one gallon Ziploc storage bag (SC Johnson and Son, Inc. Racine, Wis.).

Comparative 1-2 Stored in an one gallon EvertFresh bag (Evert-Fresh Corp, Houston, Tex.).

Comparative 1-3 Stored in a one gallon Double Guard bag (SC Johnson and Son, Inc. Racine, Wis.).

Comparative 1-4 Stored in a medium size Frigesmart container (Tupperware Corp. Orlando, Fla.).

Example 3 Stored with in an one gallon Ziploc bag with a sachet containing 20 grams citric acid, 5 grams NaHCO₃, 5 grams Na₂CO₃.

The CO₂ and O₂ Concentration in Bags/Container with Produce.

| | | | | | Double | | | | | |
|---|---|---|---|---|---|---|---|---|---|---|
| | Control | | EvertFresh | | Guard | | Frigesmart | | Sachets | |
| Test #. | C1-1 | | C1-2 | | C1-3 | | C1-4 | | E3 | |
| Date | O2 | CO2 | O2 | CO2 | O2 | CO2 | O2 | CO2 | O2 | CO2 |
| Day 1 | 5.09 | 9.5 | 7.6 | 8.1 | 14.5 | 5.4 | 15.2 | 7.0 | 10.3 | 15.8 |
| Day 4 | 4.50 | 15.4 | 9.0 | 8.9 | 6.6 | 9.2 | 14.8 | 9.0 | 5.2 | 24.2 |
| Day 6 | 5.41 | 9.8 | 13.0 | 7.6 | 7.6 | 10.0 | 14.8 | 8.3 | 9.5 | 22.5 |
| Day 7 | 1.90 | 10.6 | 10.0 | 9.0 | 6.4 | 10.2 | 13.4 | 10.0 | 8.1 | 25.2 |
| Day 11 | 0.80 | 10.6 | 14.2 | 6.8 | 4.1 | 11.4 | 13.2 | 11.9 | 8.8 | 15.7 |
| Day 12 | 1.00 | 10.6 | 13.8 | 7.5 | 5.3 | 11.4 | 12.7 | 12.8 | 9.5 | 13.6 |
| Day 13 | 12.50 | 8.3 | 14.5 | 7.3 | 19.1 | 2.1 | 13.6 | 10.3 | 18.0 | 4.7 |

### Example 4 and Comparative Example 2

### Panel Assessment of Freshness of Strawberries After Storage

Strawberries are purchased from a local grocery store and stored in a refrigerator using following methods.

Comparative 2-1 Open air: stored in the original open-air plastic container from the store

Comparative 2-2 Bag only: stored in one-gallon Ziploc storage bag

Example 4 Bag with sachets: stored in one gallon Ziploc bag along with a sachet containing 20 grams citric acid, 5 gram sodium bicarbonate and 5 grams of sodium carbonate. The strawberries are observed and assessed by panelists after 12 days and 18 days of storage. The panelists assign a rating from 0 to 4, with 0 being no difference and 4 being the most difference. The results are in Table 4.

TABLE 4

| | Rating | Rating | |
|---|---|---|---|
| | after | after 18 | |
| Example number | 12 days | days | Comments |
| Comparative 2-1 | 3.7 | 3.8 | 3/7 berries show mold and are |
| | | | dehydrated |
| Comparative 2-2 | 3.2 | 2.2 | 5/7 berries are damaged and show |
| | | | soft, dark, and mold areas |
| 4 | 1.3 | 3.6 | No significant damage or |
| | | | dehydration |

### Example 5 and Comparative Example 3

### Sweetness of Fruits After Storage

The sweetness of fruits is assessed by soluble solids content (SSD), an indicator used by United States Department of Agriculture (USDA) to assess fruit sugar level. SSD is measured by a refractometer and a numerical value is assigned.

Two samples are tested in Comparative Example 3. Comparative 3-1 is fruit stored in open air. Comparative 3-2 is fruit stored in a bag. Example 5 is fruit stored in a plastic bag with a sachet according to this invention. The results are in Table 5.

The decrease of SSD in bag-only storage (Comparative 3-2) indicates that the sachets help to retain the sweetness of the fruits. The increase of SSD in open-air (Comparative 3-1) storage for grapes and strawberries is due to the dehydration, a concentration effect.

TABLE 5

| | Example | | |
|---|---|---|---|
| | Comparative | Comparative | |
| | 3-1 | 3-2 | Example 5 |
| Apples stored for 2 months | 9.9 | 12.2 | 14.0 |
| Grapes stored for 3 weeks | 20.2 | 14.1 | 15.2 |
| Strawberries stored for 3 days | 10.9 | 10.2 | 10.3 |
| Strawberries stored for 8 days | 10.9 | 7.8 | 8.6 |

### Example 6 and Comparative Example 4

### Texture of Fresh Produce After Storage

The texture of fresh produce is assessed using a texture analyzer. For apples, grapes, and tomatoes, compressing tests are used to assess the firmness of the fruits. For celeries, a bending test is used to assess the stiffness. For lettuces, a puncturing test is used to assess the toughness of lettuce leaves. In each test, force is measured in grams.

Comparative 4-1 represents produce stored in open air. Comparative 4-2 represents produce stored in a plastic bag. Example 6 represents produce stored in a plastic bag with a packet according to this invention.

TABLE 6

| | Example | | |
|---|---|---|---|
| | | Com- | |
| | | parative | |
| | Comparative 4-1 | 4-2 | Example 6 |
| Apples stored | 3200 (mushy texture) | 6600 | 8500 (crispy texture) |
| for 2 months | | | |
| Grapes stored | 1600 (soft texture) | 2170 | 2200 (firm texture) |
| for 3 weeks | | | |
| Celery stored | 290 (limp texture) | 450 | 600 (rigid texture) |
| for 3 weeks | | | |
| Tomatoes | 75 (soft texture) | 400 | 1300 (firm texture) |
| stored for | | | |
| 3 weeks | | | |
| Lettuce stored | 1100 (tough texture) | 760 | 1100 (crunchy texture) |
| for 3 weeks | | | |

All documents cited in the Detailed Description of the Invention are, in relevant part, incorporated herein by reference; the citation of any document is not to be construed as an admission that it is prior art with respect to the present invention.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. An atmosphere modifying device comprising:
a. a carbon dioxide emitter, wherein the carbon dioxide emitter emits carbon dioxide at a rate of about 1 cubic centimeters per hour or greater, and
b. an oxygen scavenger.

2. The device of claim 1, wherein the carbon dioxide emitter comprises:
i. a carbonate selected from the group consisting of a monocarbonate, a bicarbonate, and combinations thereof; and
ii. an organic acid.

3. The device of claim 2, wherein ingredients i and ii are present in a molar ratio ii:i of about 0.3:1 to about 5:1.

4. The device of claim 2, wherein the monocarbonate and the bicarbonate are present in a molar ratio monocarbonate:bicarbonate of about 0:1 to about 100:1.

5. The device of claim 2, wherein the monocarbonate is sodium carbonate, the bicarbonate is sodium bicarbonate, and the organic acid is citric acid.

6. The device of claim 2, wherein the carbonate has an average particle size of about 5 to about 1000 micrometers.

7. The device of claim 1, wherein the oxygen scavenger is selected from the group consisting of an iron source mixed with a salt and ferrous carbonate mixed with ascorbic acid.

8. The device of claim 7, wherein the amounts of the iron source and the salt are selected such that the oxygen scavenger removes oxygen at a rate of about 5 cubic centimeters per hour or greater.

9. The device of claim 1, further comprising: c. an ethylene scavenger.

10. The device of claim 9, wherein the ethylene scavenger is selected from the group consisting of CaO₂, modified alumina, zeolite impregnated with permanganate, activated carbon, and combinations thereof.

11. The device of claim 10, wherein the device comprises a first compartment containing the carbon dioxide emitter, a second compartment containing the oxygen scavenger, and a third compartment containing the ethylene scavenger; wherein the first, second, and third compartments comprise a gas permeable material.

12. The device of claim 11, wherein the first, second, and third compartments comprise a liquid impermeable material.

13. The device of claim 9, wherein the device comprises a compartment containing more than one of components a, b, and c.

14. The device of claim 9, wherein components a, b, and c are generally recognized as safe materials.

15. The device of claim 9, wherein the device further comprises one or more components selected from the group consisting of:
an activator,
a controller controlling emission rate of carbon dioxide and scavenging rate of oxygen and ethylene,
a moisture controlling mechanism,
a biological active,
a carbon monoxide emitter, and
an antimicrobial emitter.

16. A package for keeping produce fresh comprising:
i. a container, and
ii. an atmosphere modifying device according to claim 1 contained within the container.

17. The package of claim 16, wherein the package further comprises one or more components selected from the group consisting of:
an activator,
a controller controlling emission rate of carbon dioxide and scavenging rate of oxygen and ethylene,
a moisture controlling mechanism,
a biological active,
a carbon monoxide emitter, and
an antimicrobial emitter.

18. The package of claim 16, wherein the device modifies the atmosphere in the headspace of the container to contain about 2 to about 21 volume % oxygen, about 0.5 to about 40 volume % carbon dioxide, and about 0 to about 10 parts per million ethylene.

19. The package of claim 18, wherein the device modifies the atmosphere in the headspace of the container to contain about 5 to about 10 volume % oxygen, about 3 to about 15 volume % carbon dioxide, and about 0 to about 0.1 part per million ethylene.

20. The package of claim 16, wherein the device modifies the atmosphere in the headspace of the container within about 0.5 to about 24 hours after produce is placed in the container and the container is closed.

21. The package of claim 16, wherein the container comprises a first compartment for containing the atmosphere modifying device and a second compartment for containing produce, wherein the first compartment and the second compartment are separated by a liquid and vapor permeable barrier.

22. The package of claim 16 wherein said container and said atmosphere modifying device are integrated into a single component.

23. A method for prolonging storage life of produce comprising:
1) placing the produce in a container with an atmosphere modifying device according to claim 1, and
2) closing the container.

24. The method of claim 23, further comprising:
3) opening the container to add or remove produce at least one time, and
4) reclosing the container.

25. The method of claim 23, wherein the device modifies the atmosphere in the headspace of the container to contain about 2 to about 21 volume % oxygen, about 0.5 to about 40 volume % carbon dioxide, and about 0 to about 10 parts per million ethylene after the completion of step 2).

26. The method of claim 25, wherein the device modifies the atmosphere in the headspace of the container to contain about 5 to about 10 volume % oxygen, about 3 to about 15 volume % carbon dioxide, and about 0 to about 0.1 part per million ethylene.

27. The method of claim 23, wherein the device modifies the atmosphere in the headspace of the container within about 0.5 to about 24 hours after the completion of step 2).

28. The method of claim 24, wherein the device modifies the atmosphere in the headspace of the container to contain about 2 to about 21 volume % oxygen, about 0.5 to about 40 volume % carbon dioxide, and about 0 to about 10 parts per million ethylene after step 4).

29. The method of claim 28, wherein the device modifies the atmosphere in the headspace of the container to contain about 5 to about 10 volume % oxygen, about 3 to about 15 volume % carbon dioxide, and about 0 to about 0.1 part per million ethylene.

30. The method of claim 24, wherein the device modifies the atmosphere in the headspace of the container within about 0.5 to about 24 hours after step 4).

31. The method of claim 23, further comprising washing the produce prior to step 1).

32. The method of claim 31, further comprising drying the produce after washing.

33. The method of claim 23, further comprising refrigerating the container.

34. A method for promoting sale of produce comprising: providing informational indicia in association with the produce to indicate and/or communicate to a consumer of the produce that the produce can be kept fresh for longer periods of time by storing the produce in a package comprising:
i. a container, and
ii. an atmosphere modifying device according to claim 1 contained within the container.

35. A kit for prolonging the storage life of produce comprising:
a) an atmosphere modifying device according to claim 1,
b) a gas impermeable packing material containing the atmosphere modifying device, and
c) information or instructions, or both, describing how to use the atmosphere modifying device.

36. The kit of claim 35, further comprising:
d) a container.
